(19) United States
(12) Patent Application Publication
(10) Pub. No.: US 2009/0134597 A1
(43) Pub. Date: May 28, 2009

(54) VEHICLE PROPELLED BY MUSCLE POWER, IN PARTICULAR STEP SCOOTER

(75) Inventors: Martin Buchberger, Innsbruck (AT); Peter Buchberger, Innsbruck (AT)

Correspondence Address: Zilka-Kotab, PC, P.O. BOX 721120, SAN JOSE, CA, 95172-1120, US

(73) Assignee: GRADITECH ENTWICKLUNGS GMBH, INNSBRUCK-VILL (AU)

(21) Appl. No.: 12/095,616

(22) PCT Filed: Nov. 30, 2006
(86) PCT No.: PCT/EP06/11505

§ 371 Date: Sep. 30, 2008

(30) Foreign Application Priority Data
Nov. 30, 2005 (AT) 1929/2005

(51) Int. Cl. B62M 1/04

(52) U.S. Cl. 280/251

(57) ABSTRACT

Vehicle propelled by muscle power, in particular scooter, with at least one driving wheel and at least one tread surface (5, 5′) which is movable via a tread surface stroke, wherein the force transmission from the at least one tread surface (5, 5′) to the at least one driving wheel takes place by means of a driving element (6, 6′) which is guided with a nonpositive fir via a drive shaft (8, 8′) which is coupled to the driving wheel via a freewheeling mechanism, wherein the drive shaft (8, 8′) and/or preferably at least one deflecting roller (7, 7′) is/are divided into at least two axial regions (7b, 7c; 7b′, 7c′, 8a, 8b; 8a′; 8b′) with radii which differ from one another or are variable, and the driving element (6, 6′) is divided into partial sections with different cross sections which are designed in such a manner that the partial sections (6a, 6b 6c; 6a′, 6b′ 6c′) of the driving element (6, 6′) are guided within the tread surface stroke (O-U) on the respectively corresponding axial region of the drive shaft (8, 8″) and/or deflecting roller (7, 7′). As a result, the overall transmission ratio (uges) of the vehicle can be configured within the tread surface stroke (O-U) within wide limits, wherein, in particular, the drive shaft (8, 8′) which is designed according to the invention can undertake a plurality of revolutions without colliding with a driving element.

### FIELD OF THE INVENTION

The invention relates to a vehicle propelled by muscle power, in particular step scooter (Stepproller), with at least one driving wheel and at least one step surface, which is movable via a step surface stroke, wherein the force transmission from the at least one movable step surface to the driving wheel takes place via a driving element, one end of which is coupled to the motion of the step surface and which is guided with a non-positive or positive fit via a drive shaft, which is coupled to the at least one driving wheel via a freewheeling mechanism.

### BACKGROUND OF THE INVENTION

Exemplary embodiments of vehicles propelled by muscle power, which are driven by the driver by at least one step surface, which is movable via a step surface stroke and which also comprise a steering device, are identified as pedal mobile, scooter, see-saw scooter or lever-propelled bicycle, for example. As a rule, such vehicles are equipped with one, but in particular with two such step surfaces, for example in the form of levers, which are preferably alternately moved by the driver, in particular by a stepping motion. Oftentimes, the step surface is supported so as to be pivotable about an axis in a certain angle. However, exemplary embodiments are also known in which the step surface is not supported so as to be pivotable in a certain angle, but where the angle between step surface and direction of motion of the vehicle changes little or not at all. With such embodiments, the step surface is mostly moved forwards and backwards or upward and downward or combined forwards and backwards as well as upward and downward.

After a step surface motion has taken place in one direction and after the step surface was subsequently released again, the at least one step surface is mostly moved back into its initial position by a spring device. However, exemplary embodiments with two step surfaces are also known, where the return of the step surfaces into the initial position takes place via a coupling by an alternating load on the two step surfaces. This coupling of the two step surfaces can take place, for example, by mechanical or hydraulic elements, tackle or chain hoists or by fixing the two step surfaces to a see-saw.

With such step scooters, the transmission of the step surface path into covered vehicle distance takes place via one driving element for each step surface, for example. As a rule, this driving element is designed as a preferably flexible (biegeweich) and elongation-proof (dehnungssteif) pulling element and is guided with a non-positive or positive fit via a so-called drive shaft, which is coupled to the driving wheel via a freewheeling mechanism (or a non-return device (Richtgesperre)). This coupling between each of the drive shaft assigned to a step surface and the driving wheel by a freewheeling mechanism is in each case required for the vehicle to be capable of continuing to move during the return stroke of the step surfaces—and thus during the return motion of the respective driving element—in an unhindered manner. It goes without saying that it is also possible to design this coupling not only via a freewheeling mechanism in each case, but also via additional mechanical parts, such as for example gear wheels, chains, belts or also via a gear shift—for example a gear hub.

The disadvantage of such vehicles propelled by muscle power according to the state of the art is the fact that as a rule, the transmission ratio between vehicle path and step path across the entire step surface stroke is constant or approximately constant. As a consequence, such vehicles require a gear shift for a practicable speed and load range (for example different inclines), because otherwise the step frequency becomes too large, for example at high speeds, or because certain inclines can otherwise not be handled or can only be handled with difficulty. For the most part, commercially available gear shifts are technically extensive, must be serviced by the user (lubricated, adjusted) and basically reduce the efficiency of the force transmission, which represents a particularly profound disadvantage with vehicles propelled by muscle.

Published German Patent Application DE 43 19 104 A1 shows an exemplary embodiment of a lever drive, where the transmission within the step surface stroke changes. This is attained in that the driving element is guided about a cam disk in the form of a spiral, which is coupled to a drive disk via a freewheel. The course of the transmission results from the course of the ratio of the effective radii between cam disk and drive disk. The disadvantage of this drive and of other exemplary embodiments in which the driving element is guided about a cam disk is the fact that the cam disk can undertake maximally approximately one revolution for each step surface stroke, because it would collide with the driving element in response to a further revolution. This entails that the cam disk must be correspondingly large for a practicably large step surface stroke (preferably approx. 40 cm), because the entire step surface stroke must find room on the maximally approximately one revolution of the cam disk. This represents a disadvantage in view of the design of the vehicle, as well as in particular due to the large moment of inertia of the cam disk resulting from the size of the cam disk, which performs an oscillatory motion during the vehicle operation and which must be slowed down and accelerated anew in response to each change of the direction of rotation. A further disadvantage results from the fact that the driven vehicle wheel must either be very large or, with a practicable diameter, undertakes a plurality of revolutions for each step surface stroke. As is also shown in DE 43 19 104 A1, the maximally approximately one revolution of the cam disk must thus be transmitted to the driven vehicle by a transmission gearing, such as a chain, belt or toothed gearing for example, which represents a profound disadvantage for the ease of maintenance as well as in particular for the efficiency of the drive.

### SUMMARY OF THE INVENTION

There may thus be a need to create a vehicle propelled by muscle power, with which the disadvantages of the state of the art can be reduced.

This need may be fulfilled by a device with the features according to the independent patent claim. Advantageous embodiments result from the dependent claims.

According to an exemplary embodiment, a vehicle propelled by muscle power, in particular step scooter, comprises at least one driving wheel and at least one step surface, which is movable via a step surface stroke, wherein the force transmission from the at least one step surface to the at least one driving wheel takes place via a driving element, which is adapted in such a manner that a force transmission to the drive shaft can be made possible with this driving wheel. For example, the driving element is guided with a non-positive or positive fit via a drive shaft, wherein the drive shaft is coupled to the driving wheel via a freewheeling mechanism. The drive shaft is axially divided into at least two regions with radii, which differ from one another or which are variable and the driving element comprises at least two partial sections with cross sections which differ from one another and which are designed in such a manner that a first partial section of the driving element is guided via the first axial region of the drive shaft within the step surface stroke, a second partial section of the driving element is guided via the second axial region of the drive shaft and further corresponding partial sections of the driving element are guided preferably via possible further axial regions of the drive shaft. Axial regions of the drive shaft may refer to regions, which are arranged along the drive shaft, that is, along the axis of rotation of the shaft.

In other words, the partial sections of the driving element, in particular the cross sections thereof, are designed in such a manner that each of these partial sections can arrive only at the axial region of the drive shaft, which corresponds therewith. This may make it possible to vary the effective radius of the drive shaft—and thus the transmission of the vehicle—within the step surface stroke, without a collision of the shaft with a strand (Trum) of the driving element, even if it undertakes several revolutions during a step surface stroke. An additional transmission gearing may thus be avoided in favor of the optimization of the efficiency and of the ease of maintenance.

Descriptively described, an exemplary embodiment of the invention creates a vehicle propelled by muscle power, in particular step scooter, with at least one driving wheel and at least one step surface, which is movable via a step surface stroke, wherein the force transmission from the at least one step surface to the at least one driving wheel takes place by a driving element, which is guided with a non-positive or positive fit via a drive shaft, which is coupled to the driving wheel via a freewheeling mechanism, characterized in that the drive shaft is axially divided into at least two regions with radii, which differ from one another or which are variable and in that the driving element comprises at least two partial sections with cross sections which differ from one another and which are designed in such a manner that a first partial section of the driving element is guided via the first axial region of the drive shaft within the step surface stroke, a second partial section of the driving element is guided via the second axial region of the drive shaft and further corresponding partial sections of the driving element are guided preferably via possible further axial regions of the drive shaft.

With a vehicle according to an exemplary embodiment, it may be possible, in particular, to combine the following characteristics and advantages with one another:
The step surface stroke available to the driver at the heel, that is, the maximum stroke of the step surfaces between their high position and their low position, may be at least 30 cm, preferably approximately 40 cm.
During the step surface stroke, the change of the transmission may have at least the factor 3, preferably approximately the factor 5.
During the step surface stroke, the change of the transmission may preferably be continuously increasing. When in an upper initial position, the step surface may correspond to a low transmission, for example, whereas it may correspond to a high transmission when the step surface is in a lower end position.
In particular, a transmission range may be suitable for velocities of approximately 30 km/h in the flat terrain without additional gear shift.
A transmission range without additional gear shift may be suitable, in particular, for handling inclines of at least approx. 10%, preferably also of a greater incline.
Furthermore, an optimization of the efficiency of the vehicle transmission may be possible by minimizing the mechanical elements participating in the force transmission, in particular by avoiding a transmission gearing between the drive shaft and the driving wheel, which preferably has the smaller—as compared to bicycles—wheel size of approx. 12 to 24 inches, which is advantageous for the scooter vehicles.
It may also be possible to design the drive to have a particular ease of maintenance.
By designing the driving element and the drive shaft according to an exemplary embodiment of the invention, it may be possible, in particular, for the drive shaft and the driving element to always be designed to be aligned with one another. This may also apply for the case that the driving element is wound on the drive shaft along more than one full revolution.

According to another design alternative, the drive shaft is axially divided into at least two regions, wherein at least one of these axial regions is designed in such a manner that the radius thereof preferably varies in a continuously increasing manner.

According to another exemplary design alternative, the lengths and cross sections of the partial sections of the driving element as well as those axial regions of the drive shaft, the radius of which preferably varies in an increasing manner, are designed in such a manner that all of the points, with which these axial regions of the drive shaft engage with the driving element, engage with the driving element only once within a step surface stroke, even if the drive shaft undertakes more than one revolution within one step surface stroke.

If the transmission of the vehicle is defined as the ratio of vehicle path to step surface path and if the radius of the driving wheel is characterized with R_{AR} and the effective radius of the drive shaft, which can be coupled to the driving wheel via a freewheeling mechanism, is defined as R_{w}, then the transmission of the vehicle is proportional to the ratio R_{AR}/R_{w}. By designing the drive shaft and the driving element according to an exemplary embodiment of the invention, it may thus be possible that the effective radius R_{w} of the drive shaft—and thus the transmission of the vehicle—changes within the step surface stroke, wherein it may be possible for the drive shaft to undertake more than one revolution within the step surface stroke, without colliding with a driving element strand.

In the following, the connection between step surface position and transmission of the vehicle is identified as transmission characteristic curve. Due to the design of the topology of the driving element and due to the topology of the drive shaft, in particular the course of its effective radius, it may thus be possible to configure the transmission characteristic curve in wide limits. In particular, it may be possible thereby to design the transmission characteristic curve in such a manner that, in response to ergonomically comfortable step frequency, the vehicle can handle inclines of at least approx. 10% and speeds of up to approx. 30 km/h in the plane without the driver having to operate a gear shift or having to select the transmission himself, because the actual transmission ratio may automatically adjust itself, for example depending on the step frequency and load, that is, the sum of the brake forces acting on the vehicle, such as, for example, aerodynamic resistance, rolling resistance or inclines. The transmission characteristic curve, for example, may be designed in such a manner that the transmission continuously rises from top to bottom in response to a step surface motion. Through this, the step surfaces can remain in the upper region, that is, in a low transmitted region, for example in response to a large step frequency and/or a high load while the step surfaces move in the lower region, that is, in the highly transmitted region in response to a small step frequency and/or small load. The driver may thus exert influence on the transmission and thus on the acceleration and speed of the vehicle in all driving states solely by the selection of the operating stroke and of the step frequency. The stroke of the step surfaces, within which the driver moves the step surfaces in response to a periodic step surface motion, is referred to as the operating stroke, while the stroke of the step surfaces, which is maximally available to the driver, is referred to as the step surface stroke.

According to another exemplary embodiment, the driving element is guided to the drive shaft via at least one deflection roller. In particular, provision can also be made for several deflection rollers.

According to another exemplary embodiment, at least one of the deflection rollers is axially divided into at least two regions with radii, which differ from one another, and the driving element comprises, in the section in which it is guided via this at least one deflection roller within the step surface stroke, at least two partial sections with cross sections, which differ from one another, which are designed in such a manner that the driving element within the step surface stroke is guided via at least two of the axial regions of the deflection roller. In other words, the deflection roller and the driving element according to this exemplary embodiment are designed in such a manner that within the step surface stroke, the driving element is guided in at least one partial section via the first axial region of the deflection roller and is guided in at least one further partial section via the second axial region of the deflection roller, wherein the radii of these two and, if applicable, further axial regions are different from one another. It may thus be possible to exert additional influence on the transmission characteristic curve.

If, for example, the radii of the two axial regions of the deflection roller are characterized with r₁ and r₂, the following applies: if the driving element on the step surface side as well as on the drive shaft side run on the radius r₁, for example, the transmission at the deflection roller is r₁/r₁=1. As soon as the driving element seizes on the axial region of the deflection roller with the radius r₂ at a point in time during the downward motion of the step surface, the ratio of the effective radii at the deflection roller—and thus the transmission—change continuously up to the value r₂/r₁. According to an exemplary embodiment, provision may be made for the step surface motion at this point in time to be capable of reaching its lower end point. If the step surface moves further downward until the driving element at the step surface side as well as on the drive shaft side run on the radius r₂, the transmission at the deflection roller may keep changing continuously until the value one (r₂/r₂=1) is reached again. By a corresponding design of the deflection roller and of the driving element, it may also be possible to introduce further gradients into the transmission characteristic curve, because the deflection roller may work in a partial section of the step surface stroke like a lever arm with a force and a load arm of different lengths. This further change of the transmission by at least one corresponding deflection roller may be advantageous in particular for the following reason: in practice, the radius—and thus the effective radius—of the drive shaft cannot fall below a certain value, because there must be enough space for the axis and the hub of the driving wheel within this smallest practically possible radius. Due to the fact that the effective radius at the drive shaft is limited downward, the transmission is—in case of a fixed selection of the radius—limited upward by the device shaft. However, with the corresponding design of the topology of the deflection roller and of the driving element, it may be possible to further increase the maximum overall transmission of the vehicle at least in a partial section of the step surface stroke, without having to position a transmission gearing or a gear shift in the force transmission for this purpose, for example.

According other design alternatives, provision is also made for the drive shaft as well as for at least one deflection roller to be capable of comprising more than two axial regions with radii, which differ from one another and for the driving element to be divided into correspondingly more partial sections with cross sections, which are designed according to an exemplary embodiment of the invention. With this, it may be possible to exert influence on the transmission characteristic curve of the vehicle in further partial sections of the step surface stroke. Furthermore, it is also possible to guide the driving element via more than one deflection roller and to further exert influence on the transmission characteristic curve with each of these further deflection rollers.

In summary, according to an exemplary embodiment, the drive shaft and/or preferably at least one deflection roller may be divided in each case into at least two axial regions with radii, which differ from one another or which are variable and the driving element may be divided into partial sections with different cross sections, which are designed in such a manner that the partial sections of the driving element are guided within the step surface stroke on the respectively corresponding axial region of the drive shaft and deflection roller, respectively. Such a design may make it possible to attain the above-specified advantages.

A design alternative A provides that this is attained in that the driving element comprises at least two partial sections with widths, which differ from one another or with widening elements. In this design alternative A, the drive shaft is designed as follows: the axial region with the smallest maximum radius is arranged in axial direction, that is, in the direction of the axis of the drive shaft—in the center or centrally with reference to the axial expansion of the drive shaft and the region with the next larger maximum radius is arranged in axial direction on the outside on both sides, that is, for example along the axis of rotation of the shaft further on the outside than the center region, which comprises the smallest maximum radius. Further regions, which are potentially provided, are arranged in axial direction on the outside on the both sides of the second region sorted according to the size of their maximum radius in a preferably symmetrical arrangement, that is, the result is, viewed from the center of the shaft for example, an increasing function of the maximum radii towards the edges of the shaft, which are arranged further on the outside. According to this design alternative, the first region of the drive shaft—in axial direction—is at least as wide as the driving element in its first partial section. The width can also be understood as the depth or dimensioning of the first region of the drive shaft along the shaft axis. This first region of the drive shaft can be designed as a cam disk with varying radius, for example. However, provision is also made in a design alternative for the radius of the first region not to change in the course of a revolution, which may make it possible to guide the driving element across a plurality of revolutions in a collision-free manner via this first region or to mount and wind the driving element to this first region. The second region of the drive shaft is arranged in axial direction on the outside on both sides of the first region of the drive shaft and can preferably be designed as a pair of two congruent cam disks with a variable radius, wherein the radius of this second region, during the entire course, is greater than the greatest radius of the first region. A potentially designed third region—preferably also designed as a pair of congruent cam disks—is arranged in axial direction on the outside on both sides of the second region, a fourth on the outside of the third and so forth. In other words, the region of the drive shaft with the smallest radius is arranged in axial direction in the center in design alternative A and the further regions are arranged on the outside on both sides cascaded according to increasing radii, preferably in a symmetrical arrangement. In this design alternative A, the width of the driving element and/or of the widening elements is preferably designed in such a manner that the driving element is only guided on the respectively corresponding axial region of the drive shaft in each of its partial sections, guided over the drive shaft. For example, the driving elements in its second partial section is least as wide as the cam disks of the second region of the drive shaft are spaced apart from one another in axial direction, but it is smaller than the axial distance of the cam disks of the third region of the drive shaft. In particular, it may be possible that the radius alters or changes continuously or discontinuously between the axial regions. For example, a first axial region can comprise a first radius, which can also be spirally variable, whereas a second axial region comprises a second radius, which discontinuously differs from the first radius. It may thus also be possible to design an erratic change-over in the radius in response to a change-over from the first to the second axial region. In particular, it may not be necessary to design a continuous transition, such as by a spiral between the two regions, for example.

The topology of the deflection roller in design alternative A is analogous to that of the drive shaft designed according to design alternative A, wherein it may be advantageous, however, to design all of the axial regions of the deflection roller with a constant radius in each case. The deflection roller designed according to design alternative A may thus have the following design: the axial region with the smallest radius is arranged in axial direction in the center and the region with the next greater radius is arranged in axial direction on the outside on both sides and potentially present further regions are arranged in axial direction on the outside on both sides of the second region, sorted so as to be increasing according to the size of the radius thereof, preferably in a symmetrical arrangement.

A design alternative B provides for the driving element to comprise at least one partial section with at least two legs (Stränge). The allocation of the partial sections of the driving element to axial regions of the drive shaft or deflection roller according to an exemplary embodiment results in the fact that all of the legs of the driving element are preferably arranged symmetrical to the longitudinal axis of the driving element in such a manner that the driving element in each of its partial sections is guided only via the receptive axial region of the drive shaft or deflection roller. It may thus also be possible, for example, to reverse the topology of the deflection roller—and analogously thereto the topology of the drive shaft—of design alternative A in axial direction in such a manner that the axial region of the drive shaft with the smallest (maximum) radius now comes to rest in axial direction on the very outside on both sides and the region with the greatest (maximum) radius comes to rest in axial direction in the center.

In an exemplary embodiment of design alternative B, the deflection roller and the drive shaft, respectively, thus have the following topology: the axial region with the greatest (maximum) radius is arranged in axial direction in the center and the region with the next smaller (maximum) radius is arranged in axial direction on the outside on both sides and potentially designed further regions are arranged in axial direction on the outside on both sides of the second region, sorted so as to be decreasing according to the size of their (maximum) radius in a preferably symmetrical arrangement.

With such a design of the driving element it may also be possible in response to such a topology, which is reversed to design alternative A, to enable a guiding of the partial sections of the driving element via the corresponding axial regions of the drive shaft or deflection roller, without leading to collisions of the drive shaft with the driving element, for example, when the drive shaft performs more than one revolution. However, it may also be possible to combine a driving element designed according to design alternative B with a drive shaft or deflection roller designed according to alternative A.

It goes without saying that further combinations from both design alternatives A and B are possible. A drive shaft designed according to alternative A can be combined with a deflection roller designed according to alternative B, for example, wherein the driving element, in the section in which it is guided via the drive shaft, can be designed according to alternative A and it is to be designed according to alternative B in the section in which it is guided via the deflection roller within the step surface stroke.

All of the tension-proof (zugfest) and flexible (biegeweich) pulling elements, such as textile or plastic ties, belts, ropes, cords, chains or chain belts, for example, are possible. A change of the cross section, in particular the width of the driving element in its partial sections according to design alternative A can take place according to an exemplary embodiment by the joining of driving elements of different widths, for example, or by the fixing of widening elements to the driving element. These widening elements can be designed as small plates or pins or—in particular when using ropes or cords as driving element—they can preferably be designed as rotation-symmetrical elements (e.g. ellipsoids or balls). When using driving elements, which are flexible not only in longitudinal direction but also laterally (e.g. textile ties), it may be advantageous in particular in design alternative A to laterally reinforce the driving element at least in a partial section by reinforcement elements. These reinforcement elements are preferably designed as pins or small plates, which are fixed at right angles to the longitudinal direction of the driving element, so as not to potentially reduce the flexibility of the driving element in longitudinal direction. When using a woven tie as driving element, the widening elements or the reinforcement elements can also be woven into the tie. Furthermore, it is possible and potentially advantageous for all of the design alternatives of the invention that the driving element, the widening elements, the reinforcement elements or the drive shaft and the deflection rollers are coated with substances, such as rubber or plastic, for example, so as to potentially ensure a low-noise seizing of the driving element or of the elements fixed thereon on the drive shaft and on the deflection rollers.

Furthermore, provision is made according to an exemplary embodiment for guide elements to be fixed to the driving element, which preferably ensures a laterally guided seizing of the driving element on the drive shaft and/or on the deflection rollers. Likewise, provision is made according to an exemplary embodiment for the drive shaft or the deflection rollers to be designed in such a manner that the drive element is preferably guided laterally (or, in other words, in axial direction of the respective shaft or roller).

The driving element is preferably guided via the drive shaft, which is coupled to the driving wheel via a freewheeling mechanism. It is thus possible and provided according to an exemplary embodiment to fasten the driving element to this drive shaft so as to be capable of being wound and unwound.

It is also possible, for example, to guide the driving element via the drive shaft with a non-positive or positive fit and to connect it to the frame of the vehicle or the step surface.

In all cases, however, it may be reasonable to always keep the driving element clamped by at least one spring device. Such a spring device may furthermore serve the purpose of returning the step surface back into its initial position after the step surface motion has taken place. It may thus be possible, with designs of such a vehicle propelled by muscle power with two step surfaces, to design the two step surfaces so as not to be coupled. However, couplings of the step surfaces by additional mechanical or hydraulic elements are possible.

In an exemplary embodiment the invention also provides for the driving element to be designed with a different thickness across its lengths. If the thickness of the driving element changes in the section, for example, in which it is wound onto the drive shaft, the ratio of the effective radii of driving wheel and drive shaft changes during the winding and unwinding, whereby an additional gradient may thus be introduced into the transmission characteristic curve. This change of the thickness of the driving element can take place, for example by fixing thickening elements—which—analogously to the reinforcement elements, for example—are preferably designed in such a manner that the driving element remains flexible. In particular, the thickness of the driving element can refer to the dimension of the driving element, which is at right angles to the longitudinal direction, that is, the direction of motion of the driving element and at right angles to the width of the driving element, that is, the longitudinal direction of the drive shaft or the axial direction.

In a further exemplary embodiment of the invention, provision is also made for the end of the driving element at the step surface side to be mounted so as to be adjustable. It may thus be possible to adjust the position of the drive shaft in the (upper) initial position of the step surface and, consequently, for the transmission to be designed so as to be displaceable and adjustable, respectively, at the onset—and thus also in the further course—of the step surface stroke. In other words, in so doing it may be possible to displace the driving element stroke with reference to the step surface stroke and—in connection therewith—to displace the step surface stroke with reference to the transmission characteristic curve. Different transmission characteristic cures may thus be adjustable for different speed as well as load regions (for example different inclines) without having to introduce additional mechanical elements into the force transmission for this purpose.

Furthermore, provision is made according to an exemplary embodiment of the invention for the end of the driving element at the step surface side and/or for at least one deflection roller to be mounted in a resilient manner. In so doing, the driving comfort may be increased, for example, in particular when driving over bumps.

A particular advantage of the invention may potentially be that, in spite of the manifold possibilities for designing the transmission characteristic curve, the number of mechanical elements, which share in the force transmission, to potentially be minimized, which may be advantageous for the efficiency as well as for the ease of maintenance: in an exemplary embodiment of the invention, the driving element seizes on the driving shaft, which is coupled with the driving wheel via only one freewheel, via only one deflection roller.

Furthermore, the vehicle may comprise additional advantages because of low, short and lightweight vehicle construction, in particular as compared to the common bicycle, such as, for example, better manageability, more comfort in response to the mounting and dismounting (in particular in the city) and small pack size as well as the capability of being collapsible in a design alternative, whereby it can be easily transported in a passenger car or in public means of transportation. According to an exemplary embodiment, provision is made to equip the vehicle with brakes as well as with further devices, which serve the purpose of traffic safety, such as, for example, bells, reflectors on movable and immovable parts and a lighting system. In addition, it can be provided with a splash guard as well as with a weather guard, such as a roof. It may furthermore be virtually maintenance-free. It can be designed in such a manner, for example, that there are no more parts, which must be lubricated or readjusted by the user. To attain an increased comfort, the vehicle can also be equipped with a seat or saddle as well as with devices for fastening luggage or a child seat. Furthermore, the vehicle can also be equipped with a foldable stand and with a locking device. As compared to bicycles, such step scooters may have the advantage, in particular, that the levers used in a bicycle run through two dead centers in response to a 3600 motion, which is not the case with such a step scooter. Furthermore, the standing pedaling motion may ergonomically be more beneficial than the sitting crank motion with a bicycle.

It goes without saying that design alternatives, where the here so-called step surfaces are not moved by the feet but by hand or with other body parts so that the advantages of the invention, in particular the transmission characteristic curve which can be designed within wide limits and the high efficiency can potentially also show its advantage with applications such as wheelchairs, for example.

An exemplary aspect of the invention may also be seen in creating a driving device for a vehicle propelled by muscle power, wherein the driving device comprises a drive shaft and a driving element. Along its axial direction, the drive shaft has at least one first region with a first radius and a second region with a second radius, wherein the first radius is different from the second radius. Along a length of the driving element, the driving element comprises at least one first partial section and a second partial section, wherein a cross section of the first partial section is different from a cross section of the second partial section. Furthermore, the drive shaft and the driving element are adapted to one another in such a manner that the first partial section of the driving element can be guided via the first region of the drive shaft in response to a motion of the driving element and the second partial section can be guided via the second region. Concretely, this can mean that this driving element comprises different cross sections along its length (that is, in design alternative A in particular different widths and in design alternative B in particular a different number of legs), wherein the respective cross sections of the driving element are adapted to respective axial regions of the drive shaft. In so doing it may be possible that the first partial section is only guided along the first axial region during a motion of the driving element, whereas the second partial section is only guided along the second axial region.

According to an exemplary embodiment of this aspect, the drive shaft and the driving element are adapted to one another in such a manner that the driving element is oriented so as to be aligned with the drive shaft during the entire course of the motion of the driving unit in response to a motion of the driving element. In particular, “to be aligned with” may be understood herein to mean that no lateral evasive motion of the driving element is necessary when it is unwound or wound via the drive shaft. The driving element may thus run at right angles to the axis of the drive shaft during the entire course of the motion, whereby inner losses of the driving device are potentially reduced and an efficiency of the driving device can be improved.

This may also apply in the event that more than one complete revolution of the drive shaft is performed. According to this aspect, it may thus be avoidable for the drive shaft to comprise a helical region or a helical guide with an incline in the direction of the axis of the drive shaft, via which the driving element is guided during its motion and through which the driving element performs a lateral evasive motion during its motion and not always runs at right angles on the drive shaft.

### BRIEF DESCRIPTION OF THE FIGURES

Further details and advantages of the invention are described and defined in more detail by means of the following figures:

FIG. 1 shows diagrammatically an exemplary embodiment of a scooter with two step surfaces, here designed as a lever, wherein brakes and other devices, which serve for traffic safety or for comfort, are not illustrated,

FIG. 2 shows diagrammatically an exemplary embodiment of the drive shaft according to design alternative A with two axial regions, as well as a driving element guided via the drive shaft and being designed according to an exemplary embodiment, wherein a side view is illustrated in FIG. 2a and a sectional view along line A-A is illustrated in FIG. 2b,

FIG. 3 shows diagrammatically an oblique view of the drive shaft with two axial regions as well as the driving element according to design alternative A, which is guided via this drive shaft,

FIGS. 4a-d show diagrammatically four exemplary embodiments for the driving element according to design alternative A, in each case in top view and sectional view,

FIG. 5 shows diagrammatically an exemplary embodiment of the drive shaft according to design alternative B with two axial regions as well as a driving element guided via the drive shaft and designed according to an exemplary embodiment, wherein a side view is illustrated in FIG. 5a and a sectional view along line E-E is illustrated in FIG. 5b,

FIG. 6 shows diagrammatically an oblique view of the drive shaft according to design alternative B with two axial regions,

FIGS. 7a and b show diagrammatically two exemplary embodiments of the driving element according to design alternative B,

FIGS. 8a-c show diagrammatically a change of the transmission at a deflection roller according to design alternative A,

FIG. 9a shows diagrammatically a detail view of the parts, which are important for the power transmission according to the exemplary embodiment shown in FIG. 1, wherein a change of the transmission is illustrated on the drive shaft as well as on a deflection roller according to design alternative A of the invention,

FIG. 9b shows diagrammatically the qualitative course of the transmission characteristic curve of the exemplary embodiment illustrated in FIG. 9a as a relation between the step surface position and the overall transmission of the vehicle.

### DETAILED DESCRIPTION OF EXEMPLARY EMBODIMENTS

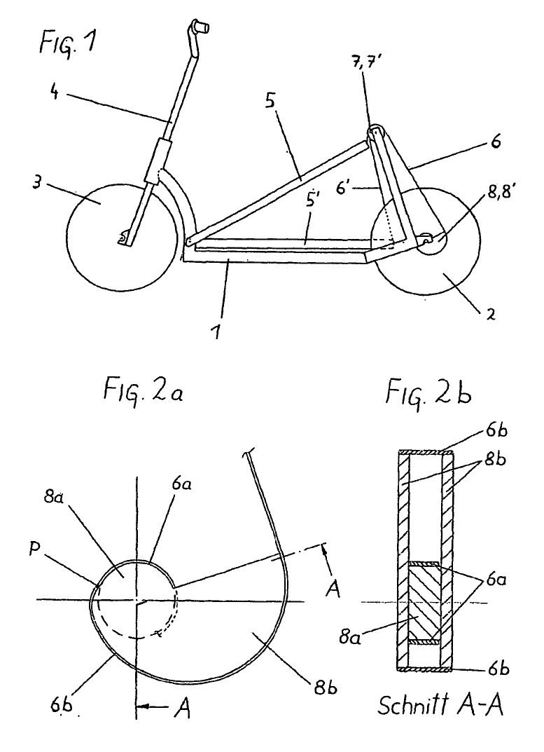

The vehicle propelled by muscle power diagrammatically illustrated in FIG. 1 represents an exemplary embodiment of a step scooter with two step surfaces 5, 5′, which are designed as levers. A vehicle frame 1, two step surfaces 5, 5′ connected to the vehicle frame 1 in a jointed manner (gelenkig), a driving wheel 2 as well as a further wheel 3, which is connected to the vehicle frame 1 in a jointed manner via a device for steering 4, are shown. In exemplary embodiments, the vehicles propelled by muscle power of this species can also comprise a plurality of driving wheels 2 or additional wheels 3. Design alternatives for more than one person are also possible. In the shown exemplary embodiment, the driving element 6 is guided from the step surface 5 shown in the upper initial position of the step surface stroke via a deflection roller 7, which is connected to the vehicle frame 1, to the drive shaft 8, which is coupled with the hub of the driving wheel 2 via a freewheeling mechanism, which is not shown in FIG. 1. The driving element 6′ is guided from the step surface 5′, which is shown in the lower end position of the step surface stroke via the deflection roller 7′ to the drive shaft 8′. The deflection roller 7′ cannot be seen in the figure, because it is located normal to the image plane precisely behind the deflection roller 7. Likewise, the drive shaft 8′ cannot be seen because it is located behind the drive shaft 8 and the driving wheel 2. In the shown exemplary embodiment, the driving element 6, 6′ is mounted on the drive shaft 8, 8′ so as to be capable of being wound and unwound and is tensed from the end thereof, which is mounted on the drive shaft by a spring device, such as a coil spring, for example, which acts on the drive shaft 8, 8′. This spring device is not illustrated in FIG. 1 and in the subsequent figures for reasons of clarity of the illustration. In the illustration shown in FIG. 1, this spring device generates a torque on the drive shaft 8, 8′ in clockwise direction, whereby the driving element is always held so as to be tensed. However, it is also possible and provision can be made in an exemplary embodiment for guiding the driving element from the step surface with a non-positive or positive fit via the drive shaft and from there to further guide it to the vehicle frame or back to the step surface and to keep this driving element strand to be tensed—and thus the entire driving element—which continues from the drive shaft and which does not contribute in the power transmission onto the drive shaft.

FIG. 2 shows diagrammatically an exemplary embodiment of the drive shaft 8 with two axial regions 8a and 8b according to design alternative A of the invention, wherein a side view is illustrated in FIG. 2a and a sectional view along line A-A is illustrated in FIG. 2b. It can be clearly seen that the axial region 8a with the smaller radius is arranged in axial direction in the center and that the region 8b with the larger radius, which is designed as two congruent cam disks, is arranged in axial direction on the outside on both sides. Furthermore, the driving element 6, which is guided via the drive shaft 8 and which is designed according to design alternative A, is illustrated in this figure, wherein it can clearly be seen that the (smaller) partial section 6a of the driving element 6 can only be guided via the axial region 8a of the drive shaft 8 and that the (wider) partial section 6b of the driving element can only be guided via the corresponding axial region 8b of the drive shaft 8. In this context, narrower means in particular that the dimensioning of the driving element in the direction of the axis of rotation of the drive shafts is less than in a region having a larger width. For clarification purposes, the location on the driving element 6 in FIG. 2a, where the partial section 6a merges into the partial section 6b, is characterized with the letter P. Furthermore, for clarifying the axial regions 8a of the drive shaft and a portion of the partial section 6a of the driving element are depicted in a dashed manner at the location where they come to rest in the side view of FIG. 2a behind the partial region 8b of the drive shaft. The end of the partial section 6a, which is not shown in FIG. 2a, is mounted on the partial region 8a of the drive shaft so that the partial section 6a can be wound and unwound on the partial region 8a of the drive shaft. For reasons of clarity of the illustrations, only one winding is shown in FIGS. 2a and 2b and in all of the following figures. However, it is possible in both design alternatives A and B and provision is also made in exemplary embodiments for the driving element in its partial section 6a to be wound on the partial region 8a of the drive shaft via a plurality of revolutions.

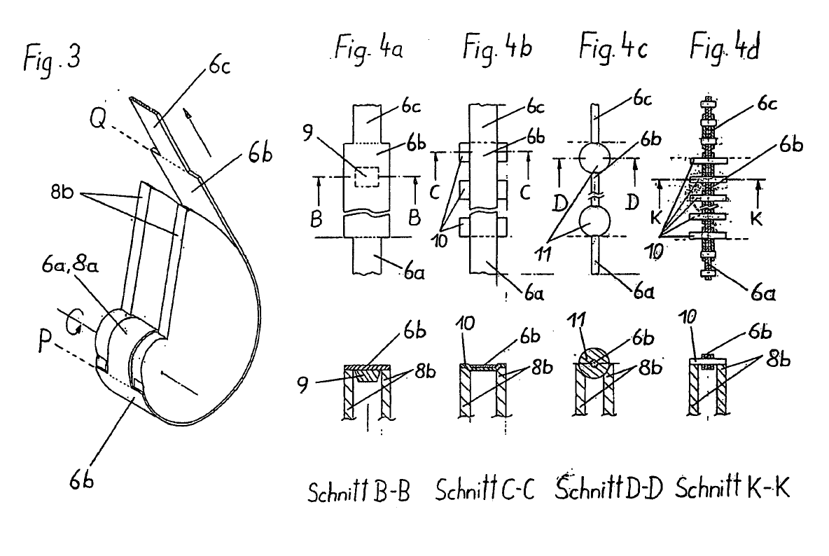

In a diagrammatic slanted view, FIG. 3 shows the drive shaft 8 with two axial partial regions 8a and 8b as well as the driving element 6 guided via the drive shaft according to an exemplary embodiment of design alternative A. It can also clearly been seen herein that the driving element 6 comprises two partial sections 6a and 6b, the cross sections of which are designed in such a manner that the driving element is guided in each of these partial sections via the respectively corresponding axial region 8a and 8b, respectively, of the drive shaft. The third partial section 6c of the driving element illustrated in FIG. 3 is not guided via the drive shaft 8, but to the deflection roller 7 illustrated in FIG. 1.

Four exemplary embodiments of the driving element 6 according to design alternative A are in each case illustrated in FIGS. 4a-d in top view and sectional view, wherein the axial region 8b of the drive shaft 8 is in each case also depicted in the sectional views for clarification purposes. FIG. 4a shows diagrammatically a driving element, which is divided into three partial sections 6a-c with different widths, wherein guide elements 9 for axially or laterally fixing the driving element on the drive shaft, are fixed to the driving element in partial section 6b. FIG. 4b shows diagrammatically an exemplary embodiment, where the change of the cross section (in particular of the width) of the driving element in a partial section 6b takes place in widening elements 10 are fixed to the driving element. In the shown exemplary embodiment, these widening elements 10 are designed in such a manner that they can simultaneously also take over the function of guide elements. FIG. 4c shows schematically a driving element, which is designed as a string or a rope, for example, and which preferably comprises rotation-symmetrical elements 11 in partial sections 6b, which serve as widening elements as well as guide elements. FIG. 4d shows an exemplary embodiment, in which the driving element 6 is designed as a flyer chain. However, other types of chains—for example roller chains—are also possible as designs of the driving element. In the exemplary embodiment shown in FIG. 4d, the widening of the driving element 6 in sections takes place by using different lengths of the chain rivets in sections, which take over the function of the widening elements 10 in section 6b.

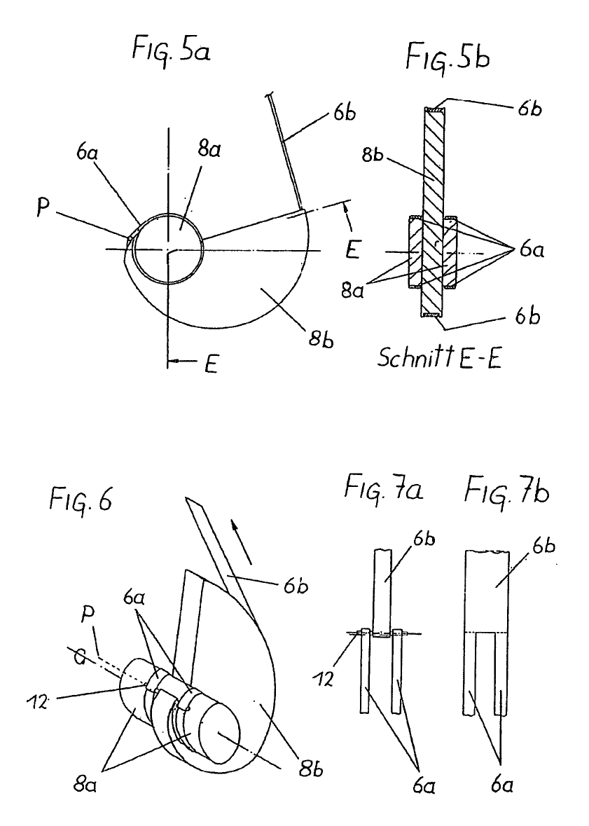

FIG. 5 shows diagrammatically an exemplary embodiment of the drive shaft 8 with two axial regions 8a and 8b according to design alternative B of the invention, wherein the side view is illustrated in FIG. 5a and the sectional view along line E-E is illustrated in FIG. 5b. It can clearly be seen that the axial region 8a with the smaller radius is arranged in axial direction on the outside on both sides and that the region 8b with the larger radius, which is designed as a cam disk, is arranged in axial direction in the center. Furthermore, this figure illustrates the driving element 6, which is guided via the drive shaft 8 and which is designed according to design alternative B, wherein it can clearly be seen that the partial section 6a of the driving element 6 has two legs, which are arranged in such a manner that they are only guided via the axial region 8a of the drive shaft 8. In the partial section 6b, the driving element consists only of one leg, which is guided only via the corresponding axial region 8b of the drive shaft 8. For clarification purposes, the location at the driving element, where the one leg of the partial section 6b merges into both of the legs of the partial section 6a, is characterized with the letter P. In the shown exemplary embodiment, the axial partial region 8b of the drive shaft, which is designed as a cam disk, is designed in such a manner that the driving element is fixed laterally, thus in the direction of the axis of the drive shaft. It goes without saying that a corresponding design for all of the axial partial regions of the drive shaft is possible in both design alternatives A and B.

FIG. 6 shows in a diagrammatic oblique view the drive shaft 8 with two axial partial regions 8a and 8b as well as the driving element 6 guided via the drive shaft according to the exemplary embodiment of design alternative B shown in FIG. 5. It can also clearly be seen herein that the driving element 6 comprises partial sections 6a and 6b, the cross sections of which are designed in such a manner that the driving element in each of these partial sections is guided only via the respectively corresponding axial region 8a and 8b, respectively, of the drive shaft. It becomes clear in this illustration, in particular, that the change of the cross section of the driving element is that the driving element comprises one leg in partial section 6b and two legs in partial section 6a. In the shown exemplary embodiment, the legs 6a and 6b of the driving element are connected by a connecting element 12, which is designed herein as a pin.

FIG. 7a and FIG. 7b show diagrammatically in top view two exemplary embodiments of the driving element 6 designed according to design alternative B. In both of the exemplary embodiments, the driving element 6 comprises one leg in partial section 6b and two legs in partial section 6a. FIG. 7a shows an exemplary embodiment, where the legs of both of the partial sections are connected by a preferably bending resistant connecting element 12.

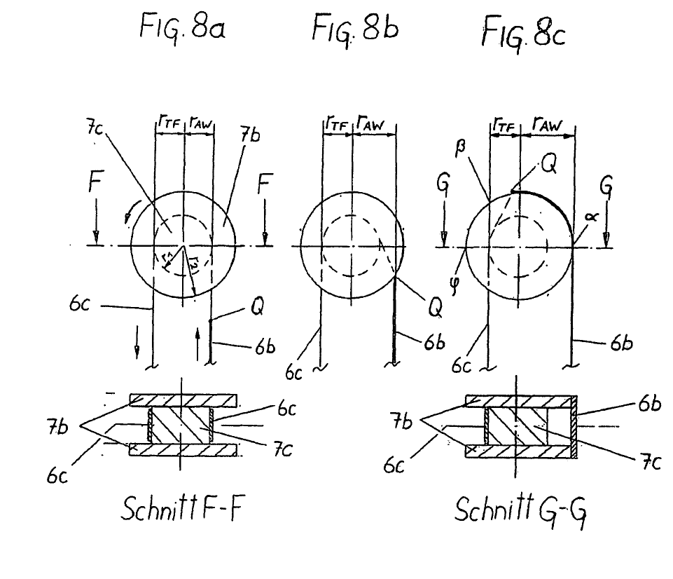

FIGS. 8a-c show diagrammatically the change of the transmission on a deflection roller 7. The illustrated deflection roller 7 comprises two axial regions according to design alternative A. The region 7c with the smaller radius r₁ is arranged in axial direction in the center and the region 7b with the larger radius r₂ is arranged in axial direction on the outside on both sides. The driving element leg with the corresponding effective radius r_{TF}, which leads to the step surface 5, is in each case depicted on the left-hand side in FIGS. 8a-c, the leg with the corresponding effective radius r_{AW}, which leads to the drive shaft 8, is in each case depicted on the right-hand side. In favor of a simple visualization of the mode of operation of the deflection roller of this exemplary embodiment, these two legs are illustrated as a special case in parallel. However, a non-parallel guide of the two legs is also possible. For clarification purposes of the partial sections of the driving element 6 designed according to design alternative A, the (wider) partial section 6b is depicted in a thick manner in the side views of FIGS. 8a-c, whereas the (narrower) partial section 6c is depicted in a thin manner. In accordance with FIG. 3, the point Q characterizes the transition between these two partial sections 6b and 6c of the driving element. FIG. 8a shows the initial situation at the deflection roller 7, before the change of the transmission becomes effective in response to a downward motion of the step surface: as long as only the partial section 6c of the driving element runs via the deflection roller, the ratio of the effective radii r_{AW}/r_{TF} (and thus also the transmission of the deflection roller) has the value one (r_{AW}/r_{TF}=r₁/r₁=1). FIG. 8b shows the situation after the (wider) partial section 6b has seized on the deflection roller with the point Q: the transmission of the deflection roller r_{AW}/r_{TF} has now increased to a value of greater than one and continuously increases in response to a further revolution of the deflection roller until it reaches the maximum value r_{AW}/r_{TF}=r₂/r₁. This situation is shown in FIG. 8c: as soon as the point Q of the driving element has reached the position α, the transmission of the deflection roller has reached the value r_{AW}/r_{TF}=r₂/r₁ and the transmission remains constant on this value in response to a further revolution of the deflection roller until point Q of the driving element has reached the position β. In response to a further revolution of the deflection roller, the transmission then continuously decreases to the value one, which is reached in response to the arrival of point Q in position φ. In the further course, the transmission of the deflection roller then remains constant at one, because r_{AW}/r_{TF}=r₂/r₂=1 now applies. The change of the transmission at the deflection roller within a partial section of the step surface stroke illustrated herein by design alternative A also is possible and provided for according to design alternative B of the driving element and the deflection roller. Likewise, it is possible and provision is made for both design alternatives A and B for the reversal of the impact of the deflection roller 7 on the transmission in such a manner that the transmission of the deflection roller in a partial section of the step surface stroke continuously decreases from the value one to the minimum value r₁/r₂ and again increases to the value one in the described manner. This can also take place, for example, by replacing the partial sections 6b and 6c of the driving element. By a suitable subdivision of the driving element into more than two partial sections it is also conceivable and possible herein to realize the raising and/or lowering of the transmission described herein into two or more partial sections of the step surface stroke with only one deflection roller. A further advantage of the invention may be that the course of the transmission of the deflection roller can be configured within wide limits by the selection of the radii of the axial partial regions of the deflection roller as well as by the selection of the length of the partial sections of the driving element. A particular advantage of the invention may also be that all of the effects described herein can be realized regardless of the number of revolutions performed by the deflection roller within a step surface stroke.

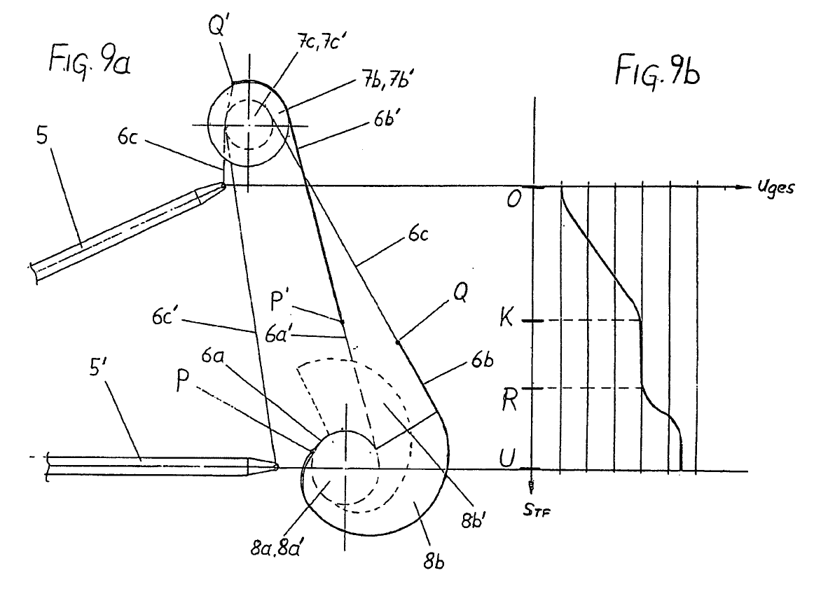

FIG. 9a shows diagrammatically a detailed view of the parts, which are important for the force transmission according to the exemplary embodiment shown in FIG. 1, wherein the change of the transmission at the drive shaft 8, 8′ as well as at the deflection roller 7, 7′ connected to the vehicle frame 1 is illustrated according to design alternative A of the invention. The step surface 5 located in the front in relation normal to the image plane, is shown in the upper end position of the step surface stroke, the step surface 5′ located in the rear is shown in the lower end position. In this exemplary embodiment, the driving elements 6, 6″ connected to the step surfaces 5, 5′ and the drive shafts 8, 8′ are designed as shown in FIG. 3, the deflection rollers 7, 7′ correspond to the exemplary embodiment shown in FIGS. 8a-c. For clarification purposes, the middle (wider) partial sections 6b, 6b′ of the driving element are depicted in a thick manner. In accordance with FIG. 3 and FIGS. 8a-c, the two ends of the partial sections 6b, 6b′ are characterized with P, P′ and Q, Q′. From the upper step surface 5, the driving element 6 runs across the axial region 7c of the deflection roller 7 to the drive shaft 8, winds around the axial partial region 8b there and is further guided around the axial partial region 8a, where the driving element 6 is wound and is mounted with its end. In this position of the step surface, the transmission at the deflection roller 7 is one and the transmission at the drive shaft 8 assumes its minimal value, because the effective radius at the drive shaft (R_{W}) assumes its maximum value. If the step surface 5 is moved downward, the drive shaft 8 turns and the driving element continuously unwinds from its axial region 8b. The effective radius R_{W} thereby decreases continuously, whereby the transmission increases continuously. After the driving element has been unwound completely from the region 8b, the transmission at the drive shaft 8 remains approximately constant in the further course of the step surface stroke, because the axial region 8a in the shown exemplary embodiment is designed in a rotation-symmetrical manner and because the effective radius R_{W} thus changes only slightly while the driving element is unwound from the region 8a. This slight change is caused by the thickness of the driving element, because fewer windings are located below the driving element leg, which is driven by the drive shaft in response to each revolution. Provision can thus also be made in an exemplary embodiment for the driving element, in particular in the partial section 6a, where it is wound onto the drive shaft, to be designed across its length with a different thickness, so as to introduce an additional gradient into the transmission characteristic curve. As soon as the point Q of the driving element now reaches the deflection roller 7 and seizes onto its region 7b, the transmission at the deflection roller increases continuously up to its maximum value according to an exemplary embodiment, whereby the overall transmission of the vehicle also continues to increase accordingly. The situation at the end of the step surface stroke is visualized by the shown lower step surface 5′. A possible position of the drive shaft 8′ belonging to the step surface 5′ is depicted in a dashed manner and it can clearly be seen that it is possible for the drive shaft 8, which is designed as two congruent cam disks in the axial partial region 8b, to make several revolutions without colliding with a driving element strand.

FIG. 9b shows diagrammatically the qualitative course of the transmission characteristic curve of the exemplary embodiment illustrated in FIG. 9a as the relation between the step surface position s_{TF} and the overall transmission uₜₒₜ of the vehicle, wherein the overall transmission is defined as the ratio between vehicle path to step surface path. The step surface stroke, which is vertically depicted in the diagram, extends from position O to position U. Position K characterizes the position of the step surface, in which point P of the driving element 6 leaves the cam disk in the region 8b. In the partial section between position O and position K, the overall transmission thus runs as described according to the course of the radius of region 8b. Position R characterizes the position of the step surface, in which point Q of the driving element reaches the deflection roller 7 and the described change of the transmission at this roller becomes effective. Due to the selection of the radii of the axial regions 7a, 7b of the deflection roller and the selection of the length of the partial sections 6b, 6c influence can be exerted on the course of the change of the transmission in partial section R-U of the step surface stroke and it is also possible in particular to design the invention in such a manner that the partial section R-U overlaps with the partial section O-K.

In addition, it is pointed out that “comprise” does not exclude any other elements or steps and that “a” or “one” does not exclude a plurality. It is furthermore pointed out that the features or steps, which have been described with a reference to one of the above exemplary embodiments, aspects or design alternatives, can also be used in combination with other features or steps of other above-described exemplary embodiments, aspects or design alternatives. Reference signs in the claims are not to be considered as limitations.

1-19. (canceled)

20. A vehicle propelled by muscle power, in particular a step scooter, which comprises:
at least one driving wheel;
at least one step surface, which is movable via a step surface stroke;
at least one drive shaft, which is couplable to the at least one driving wheel via a freewheeling mechanism; and
at least one driving element, wherein the driving element is adapted in such a manner that a force transmission from the at least one step surface to the at least one driving wheel is possible with the driving element;
wherein the at least one driving element comprises at least two partial sections with different cross sections;
wherein the at least one drive shaft is axially divided into at least two axial regions with radii, which differ from one another or which are variable;
wherein the at least two partial sections of the driving element are designed in such a manner that, within the step surface stroke, a first partial section of the at least two partial sections of the driving element is guided via a first axial region of the at least two axial regions of the drive shaft and a second partial section of the at least two partial sections of the driving element is guided via a second axial region of the at least two axial regions of the drive shaft.

21. The vehicle according to claim 20, wherein at least one of the at least two axial regions of the drive shaft is designed in such a manner that the radius thereof varies, wherein the variation is continuously increasing.

22. The vehicle according to claim 20, wherein the lengths and cross sections of the at least two partial sections of the driving element and the at least two axial regions of the drive shaft, the radii of which vary, are designed in such a manner that all points with which the at least two axial regions of the drive shaft engage with the driving element engage with the driving element exactly once during the step surface stroke.

23. The vehicle according to claim 20, further comprising:
at least one deflection roller;
wherein the driving element is guided to the drive shaft via the at least one deflection roller.

24. The vehicle according to claim 23,
wherein the at least one deflection roller is axially divided into at least two axial regions with radii which differ from one another and wherein the driving element is adapted in such a manner that, in a section in which the driving element is guided via the at least one deflection roller during the step surface stroke, the driving element comprises the at least two partial sections with the cross sections which differ from one another, the at least two partial sections being designed in such a manner that the driving element is guided via the at least two axial regions of the deflection roller within the step surface stroke.

25. The vehicle according to claim 20,
wherein the drive shaft is designed in such a manner that one of the axial regions of the drive shaft with the smallest maximum radius is arranged in axial direction in a center and in that one of the axial regions of the drive shaft with the next larger maximum radius is arranged in axial direction on an outside on both sides.

26. The vehicle according to claim 24,
wherein the at least one deflection roller is designed in such a manner that one of the axial regions of the deflection roller with the smallest radius is arranged in axial direction in a center and in that one of the axial regions of the deflection roller with the next larger radius is arranged in axial direction on an outside on both sides.

27. The vehicle according to claim 25,
wherein the driving element comprises at least two partial sections with a width which differs from one another or with widening elements

28. The vehicle according to claim 20,
wherein the drive shaft is designed in such a manner that one of the axial regions of the drive shaft with the largest maximum radius is arranged in axial direction in a center and in that one of the axial regions of the drive shaft with the next smaller maximum radius is arranged in axial direction on an outside on both sides.

29. The vehicle according to claim 24,
wherein the at least one deflection roller is designed in such a manner that one of the axial regions of the deflection roller with the largest radius is arranged in axial direction in a center and in that one of the axial regions of the drive shaft with the next smaller radius is arranged in axial direction on an outside on both sides.

30. The vehicle according to claim 20,
wherein the driving element comprises at least one partial section with at least two legs.

31. The vehicle according to claim 20,
wherein the driving element comprises reinforcement elements, which are designed as small plates or pins fixed at right angles to a longitudinal direction of the driving element.

32. The vehicle according to claim 20,
wherein guide elements are fixed to the driving element.

33. The vehicle according to claim 20,
wherein the driving element is fastened to the drive shaft so as to be capable of being wound thereon and unwound therefrom.

34. The vehicle according to claim 20,
wherein the driving element is designed so as to have a different thickness along a length of the driving element.

35. The vehicle according to claim 20,
wherein an end of the driving element at a side of the step surface is mounted so as to be capable of being adjusted.

36. The vehicle according to claim 20,
wherein at least one of an end of the driving element at a side of the step surface and at least one deflection roller is mounted so as to be resilient.

37. A driving device for a vehicle propelled by muscle power, wherein the driving device comprises:
at least one drive shaft; and
at least one driving element;
wherein the drive shaft, along an axial direction of the drive shaft, comprises at least one first region and a second region with radii which differ from one another or which are variable;
wherein the driving element, along a length of the driving element, comprises at least one first partial section and a second partial section, wherein a cross section of the first partial section is different to a cross section of the second partial section;
wherein the drive shaft and the driving element are adapted to one another in such a manner that the first partial section is guidable via the first region and the second partial section is guidable via the second region during a motion of the driving element.

38. The driving device according to claim 37,
wherein the drive shaft and the driving element are adapted to one another in such a manner that the driving element is oriented so as to be aligned with the drive shaft during a motion of the driving element.
